(19) United States
(12) Patent Application Publication
(10) Pub. No.: US 2005/0071576 A1
(43) Pub. Date: Mar. 31, 2005

(54) Data processing apparatus and system and method for controlling memory access

(76) Inventors: Eric Giernalczyk, Ottawa Ontario (CA); Malcolm Stewart, Nepean Ontario (CA); Adrian G Nita, Ottawa Ontario (CA); Denny Wong, Ottawna Ontario (CA); Andrew Stewart, Nepean Ontario (CA); Tuan Ho, Ottawa Ontario (CA); Thinh M Le, Kent Vale Singapore (SG)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/469,526

(22) PCT Filed: Mar. 4, 2002
(86) PCT No.: PCT/CA02/00278

Related U.S. Application Data
(60) Provisional application No. 60/272,301, filed on Mar. 2, 2001.

(51) Int. Cl. G06F 12/00

(52) U.S. Cl. 711/149; 711/150

(57) ABSTRACT

A data processor comprises a memory having storage elements arranged in columns and a number of column decoders, each having a memory access port. The data processor has a plurality of processing elements, and each of the memory ports is coupleable to at least a respective one of the processor elements, such that each processor element is capable of accessing at least one column of storage elements.

### FIELD OF THE INVENTION

The present invention relates to a data processor apparatus, and in particular to a system and method for controlling access to a memory which is shared by two or more data processors or other devices.

### BACKGROUND OF THE INVENTION

In a typical computer system having multiple computer processor units (CPUs) which require access to a common memory, the CPUs and memory are connected to a data communication bus for shared memory access. An example of a multi-CPU system is shown in FIG. 1. The system 1 includes a number of microprocessors 3, 5 and other devices such as a Direct Memory Access (DMA) device 7 and an input/output (I/O) device 9 connected to a data communication bus 11, which is also connected to a number of shared memory blocks 13, 15 by respective memory interface units (MIU) 17, 19. One problem with this implementation is that only one memory can be accessed by only one microprocessor or other device at any one time through the data communication bus, which often leads to a bottle neck or congestion in data transfer. For example, if microprocessors 3, 5 both require access to a memory at the same time, and one of the microprocessors has priority over the other, the microprocessor having lower priority has to wait until memory access by the higher priority microprocessor is complete. This problem becomes greater as the number of devices connected to the data communication bus increases, so that, for example, access waiting times for other devices such as the DMA and input/output devices become significantly large.

Another form of data processor is the single-instruction-multiple-data (SIMD) processor, which has multiple processor units each having its own associated memory space. The processor units are simple processors, unable to fetch or interpret instructions, and are controlled by a single control unit, so that the processor units act as slaves to the control unit, performing at its request, arithmatic-logic operations. A typical SIMD architecture is depicted in FIG. 2. The data processor 21 has a number of processing units 23, 25 each coupled to an associated memory 27, 29. The data processor has a control unit (not shown) for controlling the processing units in parallel via a data communication bus 33 and other devices such as a DMA 35 and an input/output device 37, which are also connected to the data communication bus. One advantage of this system is that more memory and processor units can be easily added to the computer. However, a disadvantage of this system is that when a processor unit requires access to the memory space of another processor unit, the transfer of data is managed by the control unit, which therefore consumes control unit processing time or cycles, and during the time data is being moved around, the processor units remain idle.

Another example of a SIMD processor is described in U.S. Pat. No. 5,956,274 issued on 21 Sep., 1999 to Duncan G. Elliot, et al, and is shown schematically in FIG. 3. In this architecture, the processing units 33 are placed within the memory, there being one processor unit per column of storage elements, each processor unit being directly coupled to the sense amplifier of each column, and whose output is coupled to the memory column decoder. While this architecture provides a large number of processor units, each tightly coupled to its own memory space, when the microprocessor requires access to memory, the processor elements must remain idle. A further disadvantage of this architecture is that the memory must be designed specifically to incorporate the processing elements.

### SUMMARY OF THE INVENTION

According to one aspect of the present invention, there is provided a data processor apparatus comprising a memory having a plurality of storage elements arranged in a plurality of columns, a plurality of column decoders, a plurality of memory ports coupled to the decoders for at least one of outputting data from the memory and receiving data for the memory, and a plurality of processing elements, wherein each of the plurality of memory ports is coupleable to at least a respective one of the plurality of processor elements, such that each processor element is capable of accessing at least one column of storage elements.

In this arrangement, the processor elements are coupleable to the external interface ports of the memory, rather than being embedded in the memory between the sense amplifiers and column decoder. Advantageously, this architecture enables a parallel data processor to be realized having a plurality of processing elements each having access to its own portion of memory, but without the requirement for knowledge of the internal memory structure, thereby considerably simplifying design, reducing design time, and offering designers the flexibility of using any suitable memory for the intended application.

In one embodiment, the data processor apparatus includes switch means between at least one, and preferably each of the memory ports, and at least one, and preferably each of the processor elements, for selectively coupling and decoupling the memory port(s) to and from the processor element(s). Advantageously, this arrangement enables the processor elements to be decoupled from the memory, so that the memory can be accessed by another device. At the same time, this allows the processor elements to continue to perform operations, for example processing data which was previously read from the memory. In one embodiment, at least one storage element is provided for at least one and preferably each processor element for storing data read from the memory before being processed by the processing elements. In one embodiment, the storage elements can be decoupled from the memory, again to enable the memory to be accessed by another device while allowing the processor elements to process data stored in the storage element(s).

According to another aspect of the present invention, there is provided a data processor apparatus comprising a memory having a plurality of memory ports for at least one of outputting data from the memory and receiving data for the memory, a processor coupleable to the memory ports, and a data bus coupleable to the memory ports, and a memory access controller for selectively coupling and decoupling the data bus to and from the memory ports.

Advantageously, this arrangement allows the data bus to be decoupled from the memory, so that the data bus can be used to transfer data, for example between different devices connected to the data bus, while the memory is being accessed by the processor.

According to another aspect of the present invention, there is provided a memory device comprising a memory having a plurality of memory ports for at least one of outputting data from the memory and receiving data for the memory, first and second data buses, each being coupleable to the memory ports, and memory access control means for selectively coupling one of the first and second data buses to the memory ports.

Advantageously, this arrangement enables each of the data buses to be decoupled from the memory so that the decoupled data bus can continue to be used by other devices, while the other data bus is coupled to the memory.

According to another aspect of the present invention, there is provided a memory device comprising a memory having a plurality of memory ports for at least one of outputting data from the memory and receiving data for the memory, a data bus having a plurality of bus lines, wherein the number of bus lines is different to the number of memory ports, and decoding means between the memory ports and the data bus for one of coupling selected ones of the memory ports to the bus lines, if the number of memory ports exceeds the number of bus lines, and coupling selected ones of the bus lines to the memory ports, if the number of bus lines exceeds the number of memory ports.

Advantageously, this arrangement provides a decoder coupled between the memory ports and a data bus having a different number of serial bit lines to the number of memory ports, and controls the selection of which memory ports are coupled to which serial bus lines to enable any size of data bus full access to any size of memory, and vice versa.

### BRIEF DESCRIPTION OF THE DRAWINGS

Examples of embodiments of the present invention will now be described with reference to the drawings, in which:—

FIG. 1 shows a block diagram of a multi-processor computer architecture according to the prior art;

FIG. 2 shows a block diagram of a single-instruction-multiple-data (SIMD) processor architecture, according to the prior art;

FIG. 3 shows a block diagram of another example of a SIMD processor architecture, according to the prior art;

FIG. 4 shows a block diagram of a data processor apparatus according to an embodiment of the present invention;

FIG. 5 shows a diagram of a data processor apparatus, according to another embodiment of the present invention;

FIG. 6 shows a diagram of a memory access controller according to an embodiment of the present invention;

FIG. 7 shows an example of a memory access controller according to another embodiment of the present invention;

FIG. 8 shows an example of a memory access controller according to another embodiment of the present invention, and

FIG. 9 shows a table of memory allocation for data received on two different buses, according to an embodiment of the present invention.

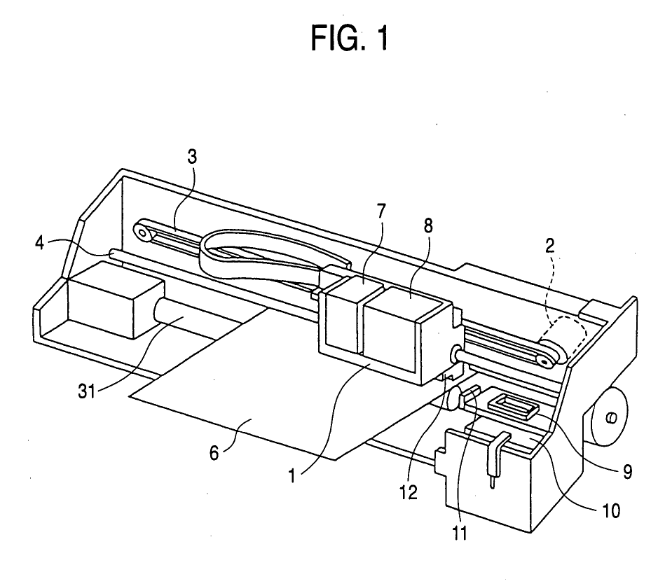

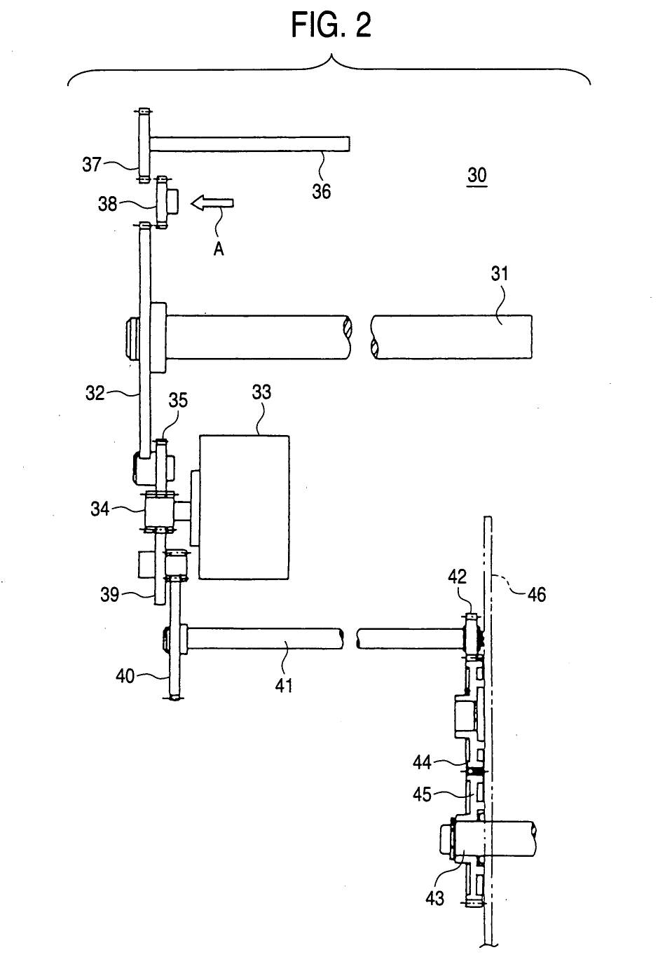

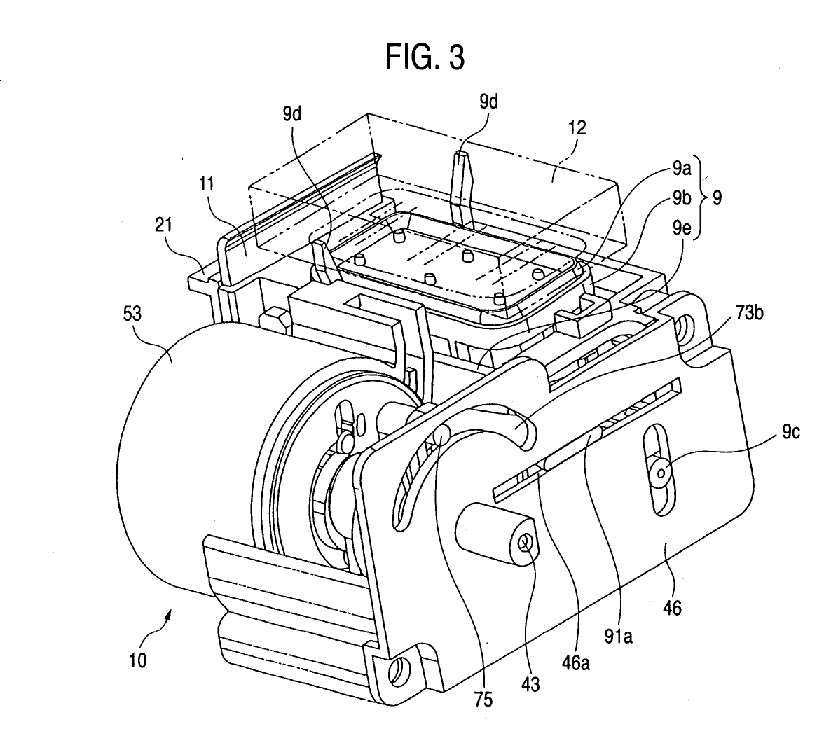

### DESCRIPTION OF EMBODIMENTS

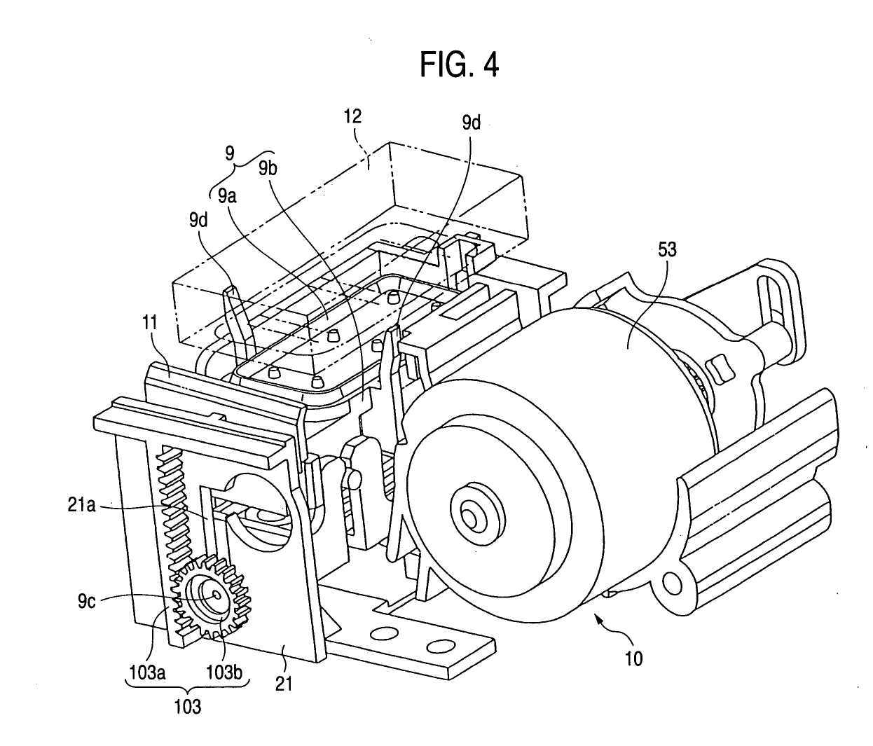

FIG. 4 shows a data processor according to an embodiment of the present invention. The data processor 101 comprises a memory 103, e.g. a random access memory, having a plurality of storage elements 105 arranged in rows 107 and columns 109 (only a few of which are shown for clarity). The memory 103 includes a row decoder (or selector) 111, a plurality of sense amplifiers 113, one for each column 109 of storage elements, and a plurality of column decoders (or selectors) 115. Each sense amplifier 113 is arranged to amplify the signal either received on the memory column line to which it is connected (in the case of a memory read), or to amplify a received signal for outputting onto the column line (in the case of a memory write). Each column selector 115 has a plurality of input/output ports 117, one being connected to a respective input/output port of the sense amplifiers. In this embodiment, each column selector 115 is arranged to select from one of eight columns 109 of memory and to connect the selected column via a respective sense amplifier 113 to an I/O port 119. The memory columns, sense amplifiers and column selectors may extend laterally to include any number of memory columns, associated sense amplifiers and column selectors, to provide the required size of memory.

In one embodiment, the memory 103 may comprise a memory bank containing a plurality of memory modules.

The data processor 101 further includes a plurality of processing elements 121 each having an I/O port 123 connected to a respective I/O port 119 of the respective column selectors 115. In this embodiment, the processor elements are arranged in a one dimensional array, and there is one processor element per column selector 115, although in other embodiments, the data processor 101 may include a processor block having two or more processor elements coupleable to each memory I/O port.

Advantageously, the processor architecture of the present embodiment, in which each processor element 121 is coupleable to a memory I/O port substantially simplifies the design process of integrating processor elements with a memory, e.g. RAM. One of the problems associated with the architecture described in U.S. Pat. No. 5,956,274 (Elliot et al) is that by placing the processing elements between the sense amplifiers and the memory decoding circuits, access to the memory design is required. However, most high performance memory structure designs are strictly guarded company secrets, and therefore the only companies that are able to add structures within the memory column decoding circuits are the memory vendors themselves, and processor design is normally outside their scope of expertise, or would require too much time. In contrast, the present architecture allows any compileable memory structure to be used for the data processor, since the processor elements are coupled to the memory I/O ports, rather than to the sense amplifiers, and therefore detailed knowledge concerning the internal memory structure is not required.

In the present embodiment, the connection between each processor element 117 and memory I/O port 119 can be regarded as a one bit line of a parallel data bus 127, which may have a width of any number of bits, e.g. 16, 32, 64, 128, 192, 256 . . . etc., or any other number.

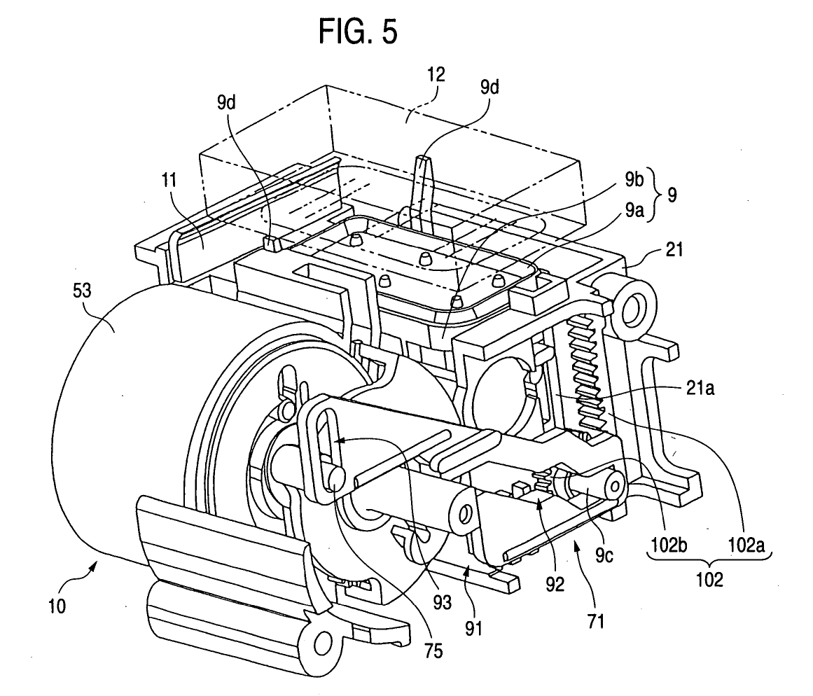

FIG. 5 shows a data processor according to another embodiment of the present invention. The data processor 201 comprises a memory 203, a parallel processing engine 205; an array controller 207, a memory arbitration unit 209, a data communication bus 211, a microprocessor 213 and one or more other devices 215, 217. The microprocessor 213 and the other devices 215, 217 are connected to the data communication bus 211. The memory arbitration unit 209 is coupled both to the data communication bus 211 and to the parallel processing engine 205, and is arranged to control access to the memory 203 by the microprocessor 213 or other device 215, 217 connected to the data communication bus 211, or by the parallel processing engine 205. The array controller 207 is also coupled to the data communication bus 211 and is arranged to control the parallel processing engine 205. The memory 203 has a plurality of I/O ports 219 (indicated schematically by the row of arrows between the memory 203 and the memory arbitration unit 209), which are coupleable through the memory arbitration unit to I/O ports 223 of the parallel processing engine 205 via a data bus 227.

In one embodiment, the memory arbitration unit 209 is adapted to selectively permit data transfer between the memory and the data communication bus 211, or between the memory 203 and the parallel processing engine 205, where the data communication bus 211, which enables data communication to and from the microprocessor 213 (and other devices 215, 217), has a different number of single bit bus lines to the data bus 227, which enables data to be transferred between the memory 203 and the parallel processing engine 205.

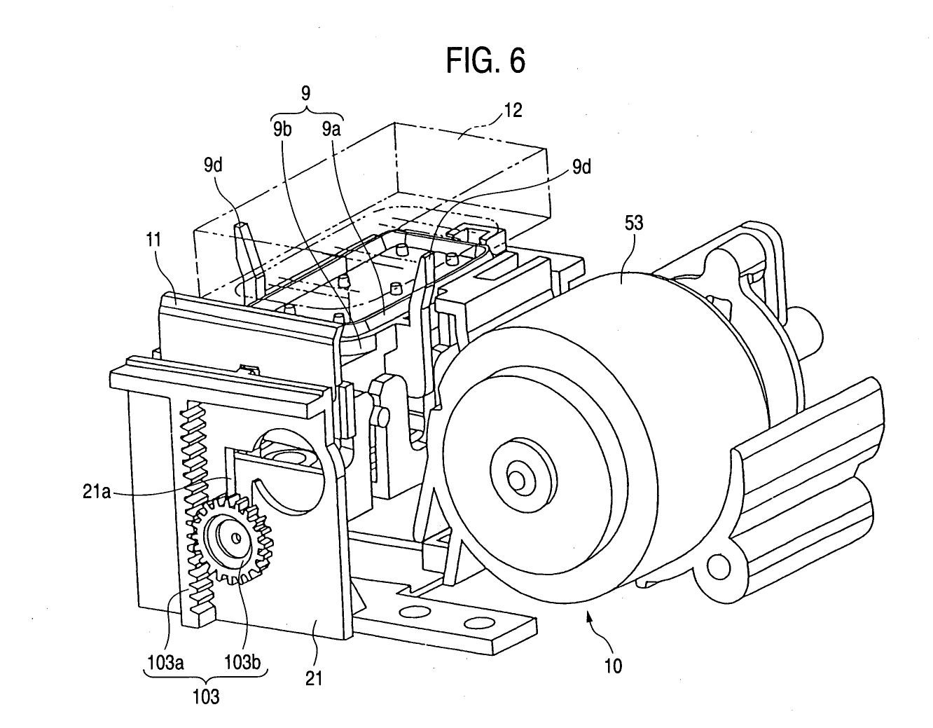

In another embodiment, the memory arbitration unit 209 is adapted to de-couple the parallel processing engine 205 from the memory 203, and to enable the processing engine 205 to continue to process data while at the same time permitting a device 213, 215, 217 coupled to the data communication bus 211 to access the memory 203. Embodiments of the arbitration unit 209 will now be described with reference to FIGS. 6, 7 and 8.

Referring to FIG. 6, a data processing apparatus 301 comprises a memory 303, a first processor 305 and one or more optional peripheral devices 307, connected to a first data bus 309. The processing apparatus 301 further includes a second processor 311 and, optionally, one or more additional peripheral devices 313 connected to a second data communication bus 315. In this embodiment, the second data communication bus 315 has a greater number of single bit lines than the first communication bus 309, and in the particular embodiment shown in FIG. 5, the first data communication bus has a single bit width of 32 (bit lines) and the second communication bus 315 has a single bit width of 192 (bit lines), although in other embodiments the first and second communication buses may have any other number of bit lines.

A memory arbitration unit 317 includes a third data bus 319 having the same number of single bit lines (i.e. bit width) as the second data communication bus 315 (in this particular embodiment 192 bit lines), each coupled to an I/O port of the memory 303. The memory arbitration unit (MAU) 317 further includes a decoder 321, one side of which is coupled to the third communication bus 319 and the other side of the decoder being switchably coupled to the first communication bus 309 via a first switching unit 323. The third bus 319 of the MAU 317 is also switchably coupled to the second communication bus 315 via a second switching unit 325.

The decoder 321 is capable of connecting each of the single bit lines of the first communication bus 309 to a selected single bit line of the third communication bus 319. For example, in read or write memory access, the decoder 321 may be controlled to connect the 32 bit lines of the first communication bus to the first 32 I/O ports of the memory via the first 32 of the 192 bit lines of the third communication bus 319, which allows, for example 4 bytes of data to be written to, or read from memory in parallel. In a subsequent operation, the decoder 321 may be controlled to connect each of the 32 bit lines of the first communication bus 309 to the next 32 I/O ports of the memory 303 via the next 32 bit lines of the 192 bit communication bus 319, thereby permitting a subsequent 4 bytes of data to be read from or written to the memory 303. The first switching unit 323 may comprise any suitable switching means which enables the first communication bus 309 to be switchably connected to and decoupled from the MAU bus 319. Preferably, the switching unit 323 is switchable between a closed position and an open (i.e. neutral or floating) e.g. tri-state position. In one embodiment, the switching unit may comprise a plurality of tri-stateable buffers, one connected in each single bit line between the decoder 321 and the first data communication bus 309.

The second switching unit 325 may also comprise any suitable means which switchably connects and decouples the second data communication bus 315 to and from the MAU data communication bus 319. Preferably, the second switching unit is switchable between closed and open (i.e. neutral or floating) positions, and, as for the first switching unit 323, may comprise a plurality of switching elements, such as a tri-stateable buffer, one connected in each bit line between the second data communication bus 315 and the MAU data bus 319.

The MAU 317 has a memory access controller 326 which controls access to the memory 303 by the device(s) coupled to the first and second data communication buses. The memory access controller may be arranged to arbitrate memory access between devices coupled to the same data communication bus 309, 311 and to arbitrate between devices coupled to different data communication buses 309, 315. In operation, the memory access controller may receive memory access requests from the various devices and may be arranged to control the connectivity between each device and memory based on predetermined rules, which may include different priorities assigned to different devices and round robin memory accesses for devices having equal priority. The memory access controller may be arranged to control the decoder 321, the first switching unit 323 to selectively connect and decouple the first data communication bus 309 to and from the memory 303, and/or the second switching unit 325 to selectively connect and decouple the second data communication bus 315 to and from the memory 303.

Advantageously, the memory arbitration unit 317 allows data buses of different widths or capacity (i.e. having different numbers of single bit lines) to be selectively coupled to a memory, and therefore allows a memory to be shared between devices which handle different length words. The MAU 317 also enables a selected communication bus to be decoupled from the memory, so that the decoupled bus can continue to be used, for example, to transfer data between devices connected to the same bus.

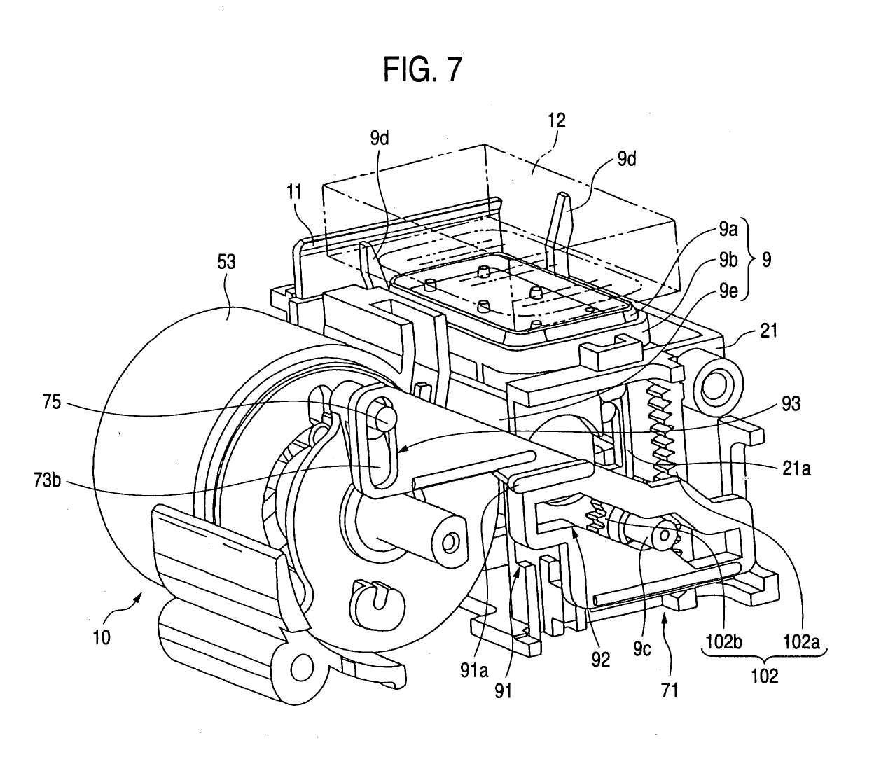

In one embodiment, the second processor 311 may include one or more registers for receiving data from the memory 303 prior to processing. Advantageously, this enables the processor to process data and at the same time the memory 303 to be accessed by another device, for example by the first processor 305, or by another peripheral device 307, 313. For example, while the second processor 311 is processing data, the result of a previous calculation by the second processor 311 stored in memory 303 may be output via the first data communication bus 309 to a device connected thereto, for example an output device. The second processor 311 may comprise a parallel processing engine containing a plurality of processor elements, similar to that described above with reference to FIGS. 4 and 5. The processing engine may be arranged to perform parallel processing on a two-dimensional array of data representative of an image. While a calculation is being performed, for example on one image frame, the memory 303 may be accessed to output a previous image frame, calculated by the two-dimensional array processor and written to the memory 303. In another embodiment, the MAU 317 may be adapted to temporarily store data from the memory 303 prior to processing by the second processor 311, which again may permit the memory 303 to be accessed by another device while the processor accesses and/or processes the stored data. An example of a memory arbitration unit having a buffer or memory is shown in FIG. 7.

FIG. 7 shows a data processor apparatus 301, which is similar to that shown in FIG. 5, and like parts are designated by the same reference numerals. The data processor has a memory 303, a first processor 305 and optionally additional peripheral devices 307 connected to a data bus 309. The memory arbitration unit 317 includes a data communication bus 319, a decoder 321 and a switching unit 323, and the description of these components given above in connection with the embodiment of FIG. 6 applies equally to the embodiment of FIG. 7. The main difference between the embodiments of FIGS. 6 and 7 is that, in the embodiment of FIG. 7, the memory arbitration unit 317 includes a plurality of register units 327, one being connected to each single bit line of the MAU data communication bus 319. In this embodiment, each register unit 327 has first and second registers 329, 331 which are separately coupleable to a respective single bit line of the bus 319, and a two to one selector switch 333 for selectively connecting the output of one of the first and second registers to a single bit line 335, each of which is connected to an input of the second processor 311. The second processor may comprise a parallel processing engine, for example having a plurality of processing elements, each of which is capable of processing data received on a single bit line to which it is connected. For example, the parallel processing engine may be similar to that described above in connection with FIGS. 4, 5 or 6.

In this embodiment, the provision of register units 327 allows data to be written from the memory 303 into the registers for processing by the processor 311. Writing to the first and second registers of the register units 327 may be controlled by a write enable signal applied to the registers, as required. The registers also provide a means for decoupling the MAU bus 319 from the registers and the second processor 311, by disabling the write enable control signal. Thus, once data has been written to one or more of the first and second registers of each unit 327, the registers can be decoupled from the MAU bus 319, for example, by disabling the write enable control signal, so that the memory 303 can be accessed by another device, for example connected to the data communication bus 309. At the same time, data stored in one or more of the first and second registers can be accessed and processed by the second processor 311. In addition to controlling the switching operations of the decoder 321 and the switching unit 323, the memory access controller 326 may also be arranged to control write operations into each of the first and second registers 329, 331, and read operations from one or more of the registers into the second processor 311.

In other embodiments, the register units 327 may have any number (i.e. one or more than one) registers, and the selector switch 333 may be omitted, for example, if the register unit contains a single register, and may be sized to switchably connect any of the registers to the second processor, if the register unit contains two or more registers.

Advantageously, the more registers that are provided per single bit line, the greater the flexibility in controlling memory access scheduling, for example between the second processor 311 and other devices connected to the data communication bus 309. Furthermore, if more than one register is used, it is possible to design the MAU and the controller of the second processor 311 to schedule and perform memory reads during periods when the memory is less active.

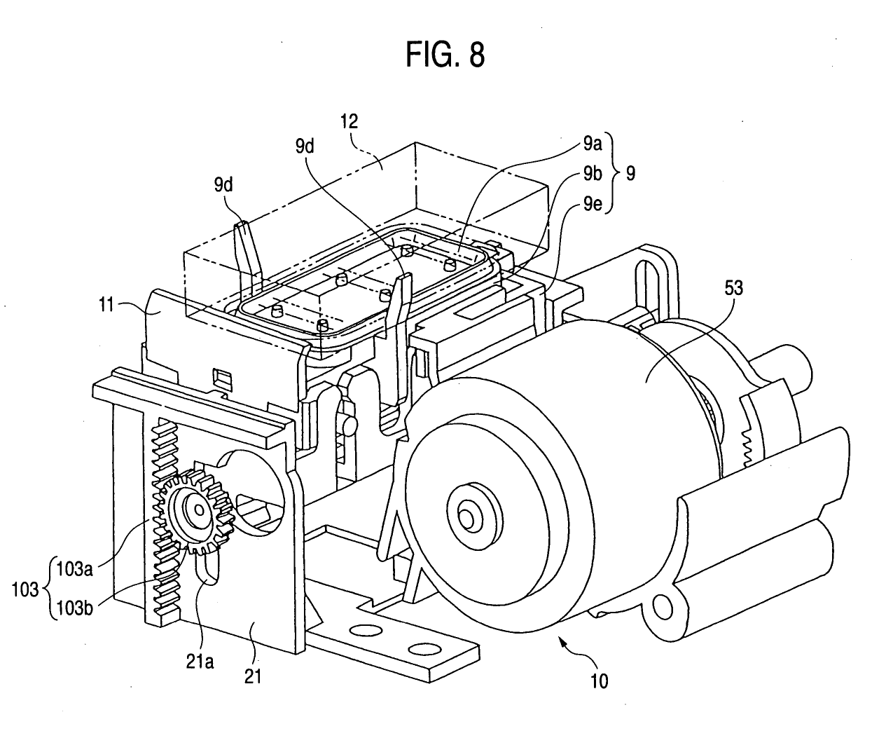

An embodiment of a data processing apparatus having a memory arbitration unit which controls write operations to memory from communication buses of different width is shown in FIG. 8.

The data processing apparatus 301 includes a memory 303, a first processor 305, and, optionally, one or additional devices 307 connected to a first data communication bus 309. The data processing apparatus also includes a second data processor 311 and, optionally, one or more further devices 313 connected to a second data communication bus 315. In this embodiment, the first communication bus comprises 32 single bit bus lines, and the second communication bus 315 has 192 single bit bus lines, although in other embodiments, the first and second data communication buses 309, 315 may have any other number of bit lines.

The data processor 301 includes a memory arbitration unit 317, having a plurality of selector switches 351, each having an output port 353 and two input ports 357, 359. In this embodiment, each of the 192 single bit bus lines of the second data communication bus 315 maps onto a memory I/O port 355, and therefore the data processor apparatus includes 192 selector switches 351 (only two of which are shown), the output 355 of each of which is connected to a respective memory I/O port 355. One of the two input ports 357, 359 of each selector switch 351 is connected to a single bit line of the second data communication bus 315.

The first communication bus 309 may be mapped onto the memory I/O ports in any desired configuration. In one embodiment, the first communication bus 309 is configured to enable byte length words or multiple byte length words to be written to memory. In one configuration, the 32 bit bus lines are divided into four groups of 8 bus lines, the first group of eight bus lines being coupled to the first inputs 357 of the first eight selector switches 351 for input to the first eight I/O ports of the memory, the second group of eight bit lines connected to the first input port 357 of the second group of eight selector switches 351, for connection to the next eight memory I/O ports, and so on, so that the third group of eight bit lines is connected to the third group of eight selector switches, and the fourth group of eight bit lines is connected to the fourth group of eight selector switches. As there are many more available I/O ports than there are bit lines on the 32 bit bus, the 32 bit lines may also be connected to the remaining I/O ports so that the bus has full access to the entire memory. In one embodiment, the first group of eight single bit lines of the first data communication bus 309 may be connected to the fifth group of eight selector switches, the second group of bit lines connected to the sixth group of eight selector switches, and so on, until the 32 bit bus has access to all memory I/O ports.

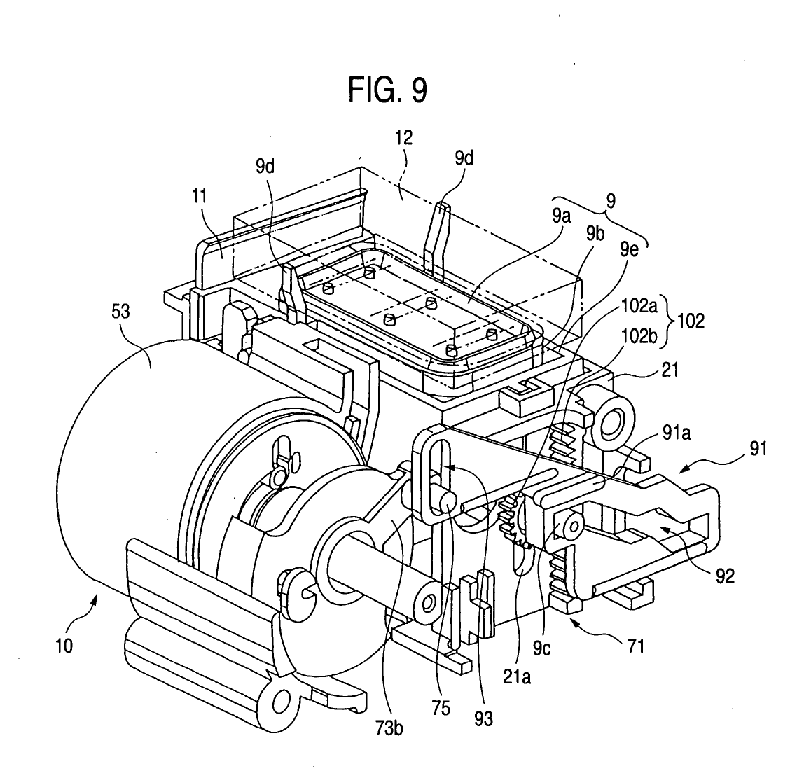

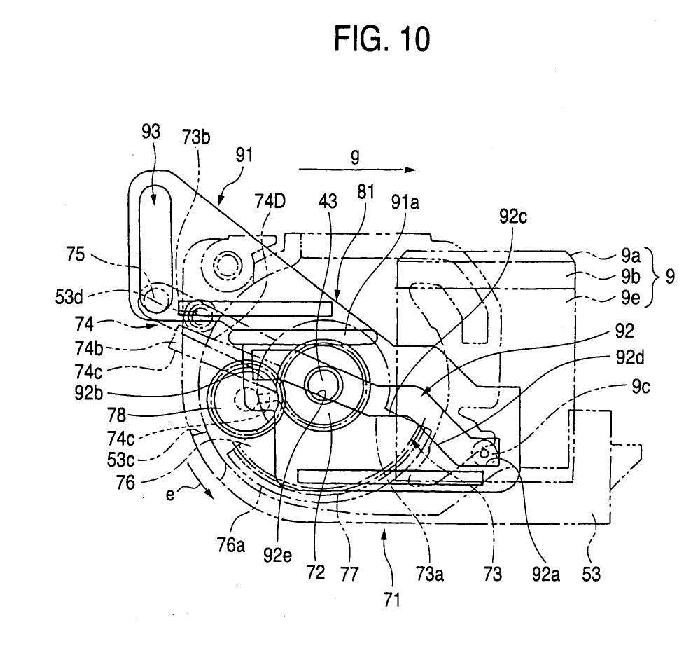

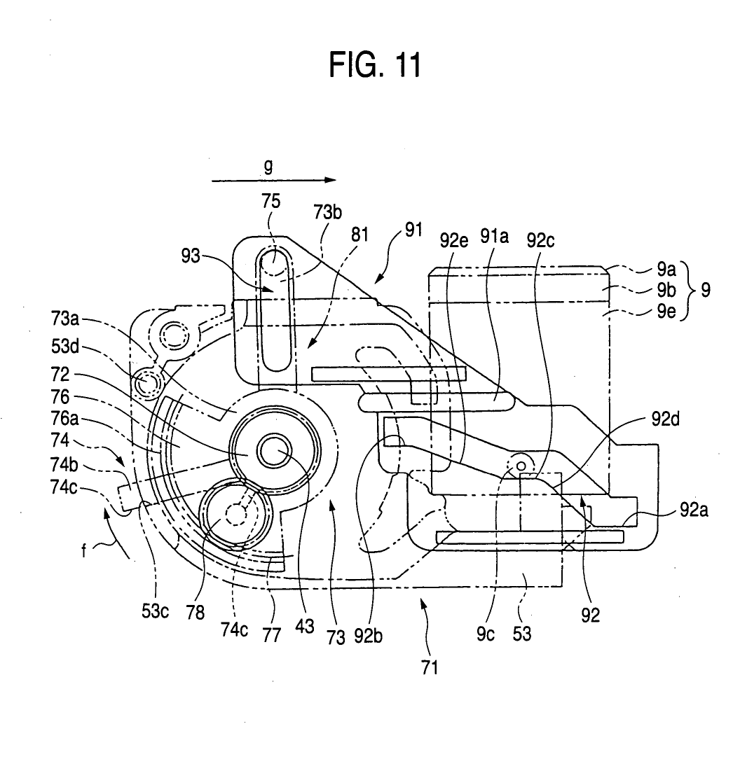

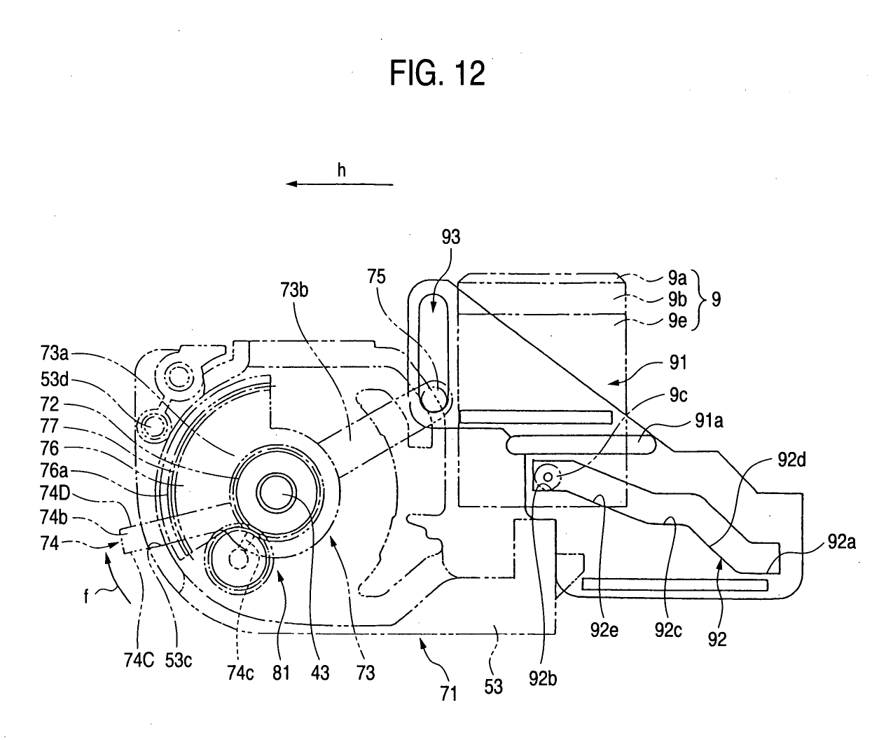

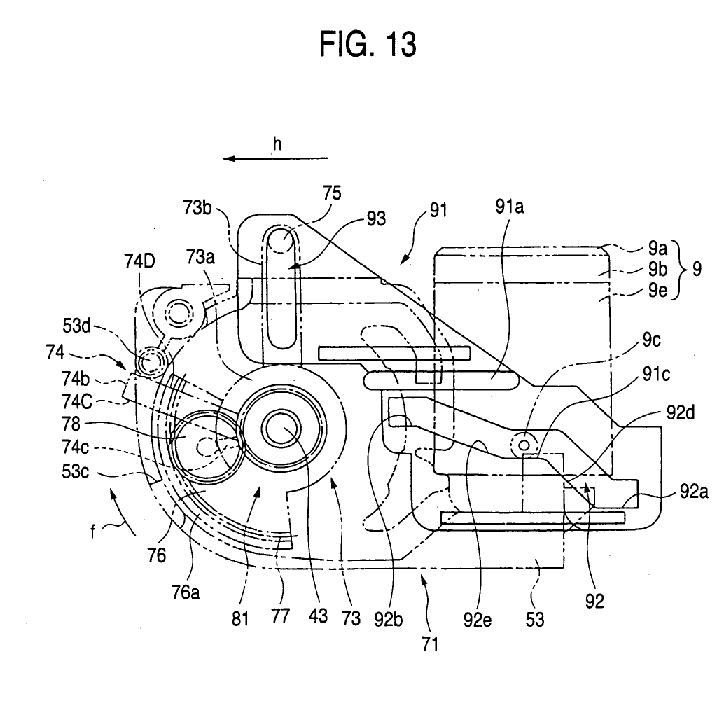

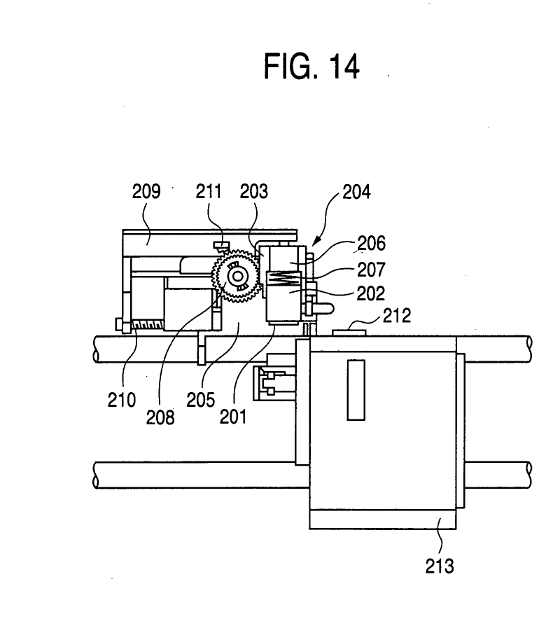

The selector switches may be controlled to allow 32 bits of data to be written to memory in parallel. During a write enable, the other selector switches coupled to memory I/O ports to which the memory write is not required, are disabled (or masked), so that copies of the same data are not written to the memory, if this is the intention. The selector switches 351 may be enabled in groups of eight by a byte write enable signal, as shown in Table 1 of FIG. 9. This allows the 32 bit data word to be divided into eight bit lengths, to allow a user to perform 8, 16 and 24 bit write operations. The selector switches may be controlled to permit byte lengths of a word having a length of two bytes or more either to be written into contiguous memory segments, or non-contiguous memory segments. In the embodiment of FIG. 8, in which the second data bus has 192 bit lines, masked writes are not required since the bus width is the same as the width (i.e. number) of memory I/Os.

Modifications and changes to the embodiments disclosed herein will be apparent to those skilled in the art.

1. A data processor apparatus comprising a plurality of processing elements, a memory having a plurality of storage elements arranged in a plurality of columns, a plurality of column decoders, a plurality of memory ports coupled to said decoders for at least one outputting data from said memory and receiving data for said memory, each of said plurality of memory ports being couplable to at least a respective one of said plurality of processor elements such that each processor element is capable of accessing at least one column of storage elements,
a device for accessing said memory,
switch means for switchably coupling each one of said plurality of memory ports to a respective processing element and for switchably coupling each one of said plurality of memory ports to said device, and
a memory access controller arranged to control said switch means to selectively couple said plurality of memory ports to one of (i) said device and (ii) said plurality of processor elements.

2. A data processor apparatus as claimed in claim 1, further comprising a data bus for coupling said memory ports to said device and further comprising a bus decoder for coupling selected memory ports to said data bus.

3. A data processor apparatus as claimed in claim 2, wherein said data bus comprises a plurality of bus lines, and said bus decoder is arranged to selectively couple selected memory ports to selected bus lines.

4. A data processor apparatus as claimed in claim 3, wherein the number of memory ports is greater than the number of bus lines.

5. A data processor apparatus as claimed in claim 2, wherein said data bus comprises a plurality of bus lines, and said bus decoder is arranged to selectively couple selected bus lines to said plurality of memory ports.

6. A data processor apparatus as claimed in claim 5, wherein the number of bus lines is greater than the number of memory ports.

7. A data processor apparatus as claimed in claim 1, further comprising a data bus for coupling said memory ports to said device, said data bus having a plurality of bus lines wherein the number of bus lines is different to the number of memory ports, and decoding means between said memory ports and said data bus for one of coupling selected ones of said memory ports to said bus lines, if the number of memory ports exceeds the number of bus lines, and coupling selected ones of said bus lines to said memory ports, if the number of bus lines exceeds the number of memory ports.

8. A data processor apparatus as claimed in claim 1, wherein said processing elements are arranged to perform operations when said plurality of memory ports are coupled to said device.

9. A data processor apparatus as claimed in claim 8, wherein said processing elements are arranged to process data previously read from said memory when said plurality of memory ports are coupled to said device.

10. A data processor apparatus as claimed in claim 1, further comprising at least one storage element for storing data received from a memory port before being processed by a respective processor element.

11. A data processor apparatus as claimed in claim 10, comprising at least one respective storage element coupled to each of said plurality of memory ports for storing data received from said memory ports before being processed by said plurality of processor elements.

12. A data processor apparatus as claimed in claim 11, comprising two or more storage elements for storing data from each of said plurality of memory ports before being processed by said processor elements.

13. A data processor apparatus as claimed in claim 1 wherein said device comprises a processor, a direct memory access (DMA) device or an input/output (I/O) device.

14. A data processor apparatus as claimed in claim 2, further comprising another device coupled to said data bus.

15. A data processor apparatus as claimed in claim 1, wherein said memory ports each comprise an I/O port.

16. A data processor apparatus as claimed in claim 1, wherein said memory comprises a random access memory (RAM) and each of said memory ports comprises an input/output (I/O) port of said RAM.

17. A data processor apparatus as claimed in claim 1, wherein each of said memory ports comprises a one-bit memory port and further comprising a single bit line of a parallel data bus between each memory port and a respective processor element for one of read access and write access.

18. A data processor apparatus as claimed in claim 2, further comprising an array controller coupled to said data bus for controlling parallel operations of said processing elements.

19. A data processor apparatus as claimed in claim 1, further comprising a data bus for coupling said memory ports to said device and an array controller coupled to said data bus for controlling parallel operations of said processor elements.

20. A device comprising a memory having a plurality of memory ports for at least one of outputting data from said memory and receiving data for said memory, a data bus having a plurality of bus lines, wherein the number of bus lines is different to the number of memory ports, and decoding means between said memory ports and said data bus for one of coupling selected ones of said memory ports to said bus lines, if the number of memory ports exceeds the number of bus lines, and coupling selected ones of said bus lines to said memory ports, if the number of bus lines exceeds the number of memory ports.

21. A device as claimed in claim 20, further comprising a processor coupleable to said plurality of memory ports, independently of said data bus.

22. A device as claimed in claim 21, wherein said processor comprises a plurality of processing elements, each coupleable to a respective memory port.

23. A device as claimed in claim 21, further comprising memory access control means for selectively coupling one of said data bus and said processor to said memory ports.
